(19) United States
(12) Patent Application Publication
(10) Pub. No.: US 2023/0161774 A1
(43) Pub. Date: May 25, 2023

(54) SEMANTIC ANNOTATION FOR TABULAR DATA

(71) Applicant: International Business Machines Corporation, Armonk, NY (US)

(72) Inventors: Udayan Khurana, White Plains, NY (US); Sainyam Galhotra, Somerville, MA (US)

(21) Appl. No.: 17/534,489

(22) Filed: Nov. 24, 2021

(51) Int. Cl. G06F 16/2457; G06N 3/08; G06N 7/00

(52) U.S. Cl. CPC G06F 16/24573; G06N 3/08; G06N 7/005

(57) ABSTRACT

An approach to column to semantic concept mapping using joint estimation through piecewise maximum likelihood estimation and utilizing large openly available structured data may be provided. The approach may include a special estimation methods for categorical, numeric, and alphanumeric/symbolic data, while unifying the overarching estimation with a common framework of likelihood estimation. The approach may also include indexes to support quick estimation computations for numeric, categorical, and mixed type data. Additionally, the approach may include semantic context utilization without a polynomial increase in mapping runtime or resource utilization.

The following disclosure is submitted under 35 U.S.C. 102(b)(1)(A): KHURANA et al., “Semantic Annotation for Tabular Data”, arXiv:2012.08594v1 [cs.AI] 15 Dec. 2020, 9 pages.

### BACKGROUND OF THE INVENTION

The present invention relates generally to the field of machine learning, more specifically, to semantic annotation of tabular data through deep learning.

Semantic annotation of structured data is crucial for numerous applications including, information retrieval, data preparation, training classification models. Semantic annotation of tabular data refers to the task of identifying real-word concepts that capture semantics of the data within the columns of a tabular table. Some techniques of semantic annotation include the utilization of knowledge graphs and natural language processing.

### SUMMARY

Embodiments of the present disclosure include a computer-implemented method, computer program product, and a system for predicting a column concept. Embodiments may include building one or more column concept indexes based, at least in part, on a plurality of reference data sources. Embodiments may also include identifying one or more concept candidates for each entity in a column based, at least in part, on the column concept indexes. Embodiments may also include calculating a probability score for each of the one or more identified concept candidates based on the column concept indexes. Additionally, embodiments may include predicting a concept for the column from the one or more identified concept candidates based, at least in part, on the calculated probability score for each of the concept candidates.

The above summary is not intended to describe each illustrated embodiment of every implementation of the present disclosure.

### BRIEF DESCRIPTION OF THE DRAWINGS

FIG. 1 is a functional block diagram generally depicting column concept prediction environment 100, in accordance with an embodiment of the present invention.

FIG. 2 is a diagram generally depicting column concept identification engine 200, in accordance with an embodiment of the present invention.

FIG. 3 is a flowchart depicting a method for predicting a column concept, in accordance with an embodiment of the present invention.

FIG. 4 is a functional block diagram of an exemplary computing system within column concept prediction environment, in accordance with an embodiment of the present invention.

FIG. 5 is a diagram depicting a cloud computing environment, in accordance with an embodiment of the present invention.

FIG. 6 is a functional block diagram depicting abstraction model layers, in accordance with an embodiment of the present invention.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the disclosure.

### DETAILED DESCRIPTION

The embodiments depicted provide for an approach to determining a semantic concept of a column within a table. In an embodiment, a concept for the column may be determined through an analysis of the entities within the column compared to a data lake built from multiple sources of table data with column headings and known entities. Further, column concept determination within a table can be extended to the comparison of multiple columns within a table, as most tables contain columns with some type of dependency, often times with a column being the primary column and other columns within a table containing data that is dependent upon the primary column.

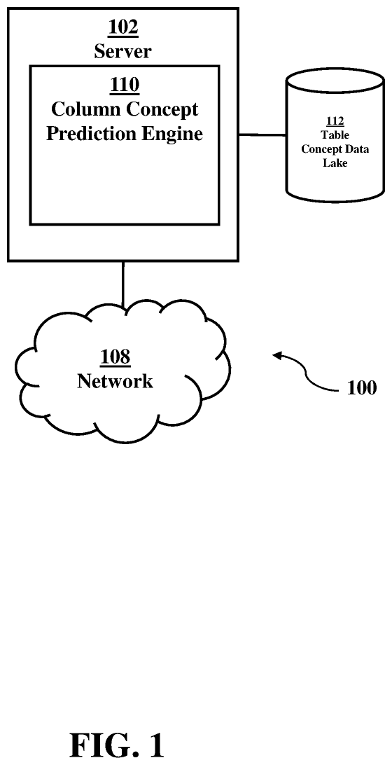

FIG. 1 is a functional block diagram generally depicting column concept prediction environment 100. Column concept prediction environment 100 comprises column concept prediction engine 110 operational on server 102, table concept data lake 112 stored on server 102 and network 108.

Server 102 can be a standalone computing device, a management server, a web server, a mobile computing device, or any other electronic device or computing system capable of receiving, sending, and processing data. In other embodiments, server 102 can represent a server computing system utilizing multiple computers as a server system. In another embodiment, server 102 can be a laptop computer, a tablet computer, a netbook computer, a personal computer, a desktop computer, or any programmable electronic device capable of communicating with other computing devices within column concept prediction environment 100 via network 108.

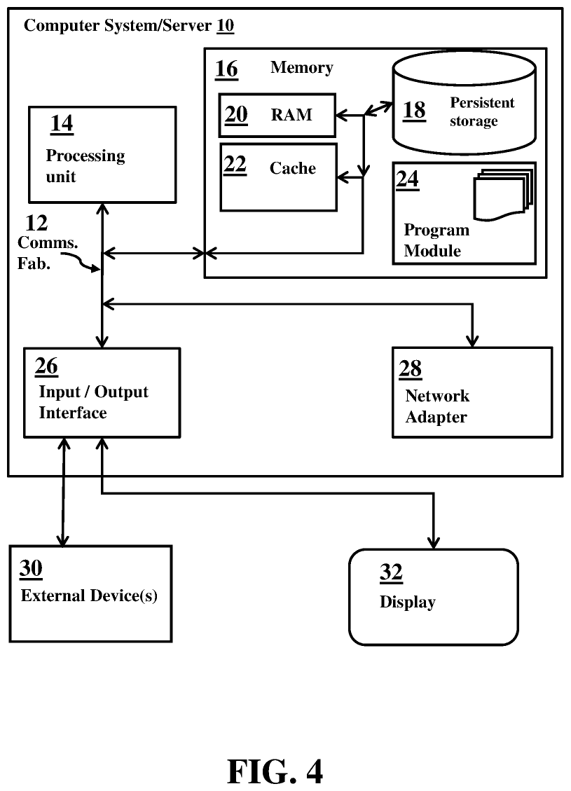

In another embodiment, server 102 represents a computing system utilizing clustered computers and components (e.g., database server computers, application server computers, etc.) that can act as a single pool of seamless resources when accessed within column concept prediction environment 100. Server 102 can include internal and external hardware components, as depicted and described in further detail with respect to FIG. 4. It should be noted, while only Server 102 is shown in FIG. 1, multiple computing devices can be present within column concept prediction environment 100. In an example, server 102 can be a part of a cloud server network in which a computing device (not shown) connected to network 108 can access server 102 (e.g., the internet).

Column concept prediction engine 110 is a computer module that can be configured to predict the concept of a column within a table. In an embodiment, column concept prediction engine 110 can prepare data for table concept data lake 112 from various data sources and analyze and predict concept headings or names for columns in a table using the prepared data stored in table concept data lake 112.

Table concept data lake 112 is a database that can be configured to store conceptual data of data sources derived by column concept prediction engine 110. In an embodiment, table concept data lake 112 can store one or more indexes such as an inverted entity count index (described further below). In another embodiment, table concept data lake 112 can store a numerical interval tree index (described further below).

Network 108 can be a local area network (LAN), a wide area network (WAN) such as the Internet, or a combination of the two, and can include wired, wireless, or fiber optic connections. In general, network 108 can be any combination of connections and protocols that will support communications between server 102 and other computing devices (not shown).

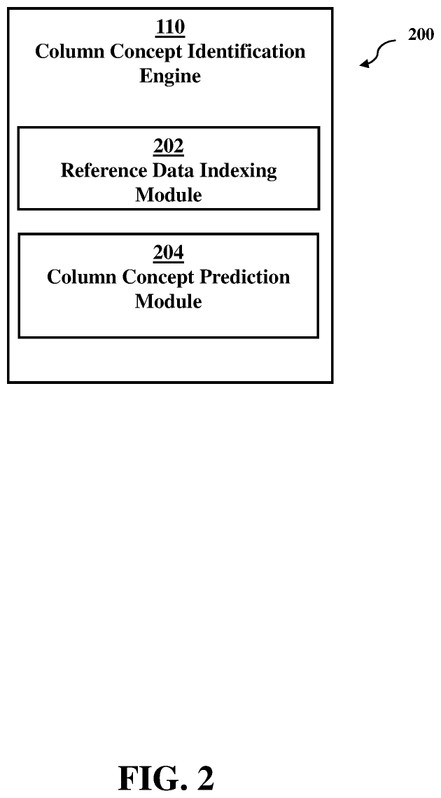

FIG. 2 is a functional block diagram 200 depicting column concept prediction engine 110. Shown operational on column concept prediction engine 110 is reference data indexing module 202 and column concept prediction module 204.

Reference data indexing module 202 is a computer program that can be configured to compile one or more indexes from one or more data sources of tabular data (e.g., DBpedia, Wikidata®, etc.) The data sources may include columns which are related by an over arching concept. Data sources may be from diverse topics and provide table concept data lake with a broad range of concepts for column prediction. Within each row of the data source columns may be entities or values which are a part of the overarching concept and linked in some manner. In an embodiment, reference data indexing module 202 can generate an inverted entity concept count index and store it on table concept data lake 112. An inverted entity concept count index is a key-value index which lists the number of times a categorical entity has been mentioned under respective column names. An inverted entity concept count index can be generated for each table within a data source, each category of tables within a data source, or for the entire data source itself.

In an embodiment, reference data indexing module 202 can generate a knowledge graph for a data source and store it in table concept data lake 112. For example, in a knowledge graph, a semantic triple can be the column name, entities, and entity properties within the column as follows: property and object or entity and type of property. Further, within the final knowledge graph, entity names can be keys, while lists of pairs (i.e., concept, count) can be values within a key-value pair. Each data source can have its own knowledge graph and the key value pairs within the knowledge graph can have a prefix for the data source.

In an embodiment, reference data indexing module 202 can generate a numerical interval tree index from data sources containing columns with numerical values and store it in table concept data lake 112. A numerical interval tree index is a modified knowledge graph. For each numerical concept within a data source, the numerical values are compared to one or more ranges established by all historical numerical values for the concept. Based on the comparison, the tree also consists of the number of times a concept was true (i.e., if the numerical values fell within that range). This is known as the count.

In an embodiment, reference data indexing module 202 can generate a composite pattern tree index and store it in table concept data lake 112. A composite pattern tree index is an index that deals with data from columns containing alpha-numeric-symbolic data (e.g., email addresses, websites, computer file names, etc.). Reference data indexing module 202 can perform a regular expression (“Regex”) generator on each entity within columns in a data source with alpha-numeric-symbolic data. Reference data indexing module 202 can aggregate the generated entity regexes and deduplicate them. Further, reference data indexing module 202 can organize the regexes into a knowledge graph with an initial branching decision on whether the regex entities contain a symbol, with the following branching decisions based on the number of symbols.

In another embodiment, reference data indexing module 202 can generate a column co-occurrence and tuple validation index from the source data and store it in table concept data lake 112. A column co-occurrence and tuple validation index is a key-value pair index that stores data about concept pairs that occur within the data source. The concept pair is stored as the key while the value(s) can be the frequency which the concept pair was found within the source data, which entity-pairs exist under the concept pair and how frequently the concept pair appeared.

In an embodiment, reference data indexing module 202 can generate a concept sharing index from the source data and store it in table concept data lake 112. A concept sharing index is an index of concept pair similarity scores. For example, reference data indexing module 202 may utilize a pre-trained encoding model (e.g., Word2vec) to generate word similarity scores for concepts within data sources. Reference data indexing module 202 may also include language hierarchy information relating to the concept pairs (e.g., synonym, antonym, etc.).

Column concept prediction module 204 is a computer program that can be configured to predict the concept of a column within a data table from the table data. In an embodiment, column concept prediction module 204 can find a number of concept candidates for each entity within a column and determine the most likely concept for each column. For example, column concept prediction module 204 can individually search for a corresponding concept for each entity in a table from the table concept data lake 112. Based on the number of times the entity shows up within a concept, a probability score can be generated for each concept which the entity is found. The likelihood all entities within a column belonging to a concept is the joint probability of all the entities.

In an embodiment, column concept prediction module 204 can search for non-numerical entities within an inverted entity concept count index. In an embodiment, column concept prediction module 204 can search an inverted entity concept count index stored on table concept data lake 112 for each non numeric entity and compile a list of concept candidates for each entity. Further, column concept prediction module 204 can calculate the probability that an entity falls under the candidate concept, where the probability is the number of times the entity was found under the concept divided by the number of times the entity was found.

In an embodiment, column concept prediction module 204 can search a numerical interval tree index stored on table concept data lake 112 for numerical entities within a table. For example, column concept prediction module 204 can search the range of numerical values (e.g., min-max) in a column against a numerical interval tree index, which has concepts and a value range or interval associated with the concept. Further, column concept prediction module 204 can count the number of intervals that intersect within the range of the column. A likelihood estimation for a candidate concept can be calculated using the total number of times the sample column range fell within the range of the concept, divided by the total number of ranges for that concept in the reference data.

In an embodiment, column concept prediction module 204 can perform a smoothing operation on retrieved concept probabilities. For example, if a concept that occurs in the list fetched for any entity of a certain column, wherever that concept is not found, column concept prediction module 204 can add a minimal count (e.g., 1) allowing the probability to be a very small number but not zero.

In an embodiment, column concept prediction module 204 can perform a concept co-occurrence search to determine how likely two concepts are to exist within a table. For example, using a predetermined number (e.g., 5 to 25) of concepts with the highest likelihood, found for categorical entities, column concept prediction module 204 can search for a number of co-occurrences of the concepts with the concept co-occurrence index and adjust the probability score of the concepts.

In an embodiment, column concept prediction module 204 can perform a tuple validation. In a tuple validation, column concept prediction module 204 can search for entities that commonly occur together under different concept headings. For example, a tuple could be person: Albert Einstein and occupation: scientist or mountain: Everest and height: 8,884 m. In tuples with numerical values, an error percentage (e.g., 5%) can be built in to allow for detection for example, if the height of Mount Everest was listed as 8,880 m in a data source, it would still be detected. However, alphabetical entities would have to match exactly to be considered a tuple. Column concept prediction module 204 can search column co-occurrence table and tuple validation index with randomly selected rows in a subject table. If a tuple match is detected, the prior calculated likelihood of all found concept candidates is multiplied by the number of times which a candidate led to a match.

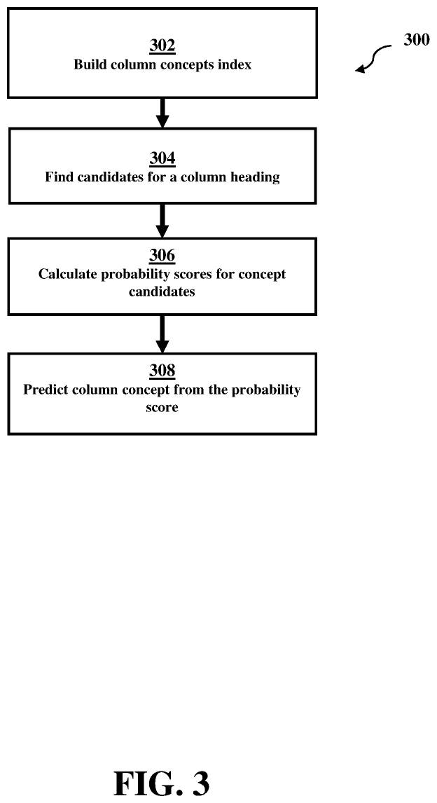

FIG. 3 is a flowchart depicting method 300 for predicting a column concept, in accordance with an embodiment of the present invention. At step 302, reference data indexing module 202 can build one or more column concept indexes. For example, reference data indexing module 202 can use data sources from web based data table to build an inverted entity concept count index for categorical entity columns within each data sources and numerical interval tree for numerical entity columns within each data source.

At step 304, column concept prediction module 204 can identify one or more concept candidates for a column of a table from the column concept indexes. For example, column concept prediction module 204 can compare each entity in a column against the indexes built by reference data indexing module 202. Each instance where the entity falls within a concept can be counted and considered a concept candidate for the column.

At step 306, column concept prediction module 204 can calculate a probability score for each of the one or more identified concept candidates. For example, each of the identified concepts for each entity can be aggregated into a total number of identifications of that concept for the column. In another example, column concept prediction module 204 can compare the aggregated concepts in one column and the aggregated concepts in another column of the table against a co-occurrence index to determine if entities are typically in the same table as one another. If it is determined entities are typically in the same table, a predetermined weight can be added to the co-occurring concepts.

At step 308, column concept prediction module 204 can predict the concept for the column based on the calculated probability score. For example, column concept prediction module 204 can use the probability score and perform a smoothing operation on the probability score to normalize the probability scores and remove noise from the samples. The concept with the highest probability score or a score above a threshold can be the prediction. In an embodiment, column concept prediction module 204 may automatically label columns with the predicted concept or rename columns with the predicted concept if it is determined a concept has a higher probability score than the current column concept label.

FIG. 4 depicts computer system 10, an example computer system representative of server 102 or any other computing device within an embodiment of the invention. Computer system 10 includes communications fabric 12, which provides communications between computer processor(s) 14, memory 16, persistent storage 18, network adaptor 28, and input/output (I/O) interface(s) 26. Communications fabric 12 can be implemented with any architecture designed for passing data and/or control information between processors (such as microprocessors, communications and network processors, etc.), system memory, peripheral devices, and any other hardware components within a system. For example, communications fabric 12 can be implemented with one or more buses.

Computer system 10 includes processors 14, cache 22, memory 16, network adaptor 28, input/output (I/O) interface(s) 26 and communications fabric 12. Communications fabric 12 provides communications between cache 22, memory 16, persistent storage 18, network adaptor 28, and input/output (I/O) interface(s) 26. Communications fabric 12 can be implemented with any architecture designed for passing data and/or control information between processors (such as microprocessors, communications and network processors, etc.), system memory, peripheral devices, and any other hardware components within a system. For example, communications fabric 12 can be implemented with one or more buses or a crossbar switch.

Memory 16 and persistent storage 18 are computer readable storage media. In this embodiment, memory 16 includes persistent storage 18, random access memory (RAM) 20, cache 22 and program module 24. In general, memory 16 can include any suitable volatile or non-volatile computer readable storage media. Cache 22 is a fast memory that enhances the performance of processors 14 by holding recently accessed data, and data near recently accessed data, from memory 16. As will be further depicted and described below, memory 16 may include at least one of program module 24 that is configured to carry out the functions of embodiments of the invention.

The program/utility, having at least one program module 24, may be stored in memory 16 by way of example, and not limiting, as well as an operating system, one or more application programs, other program modules, and program data. Each of the operating systems, one or more application programs, other program modules, and program data or some combination thereof, may include an implementation of a networking environment. Program module 24 generally carries out the functions and/or methodologies of embodiments of the invention, as described herein.

Program instructions and data used to practice embodiments of the present invention may be stored in persistent storage 18 and in memory 16 for execution by one or more of the respective processors 14 via cache 22. In an embodiment, persistent storage 18 includes a magnetic hard disk drive. Alternatively, or in addition to a magnetic hard disk drive, persistent storage 18 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 18 may also be removable. For example, a removable hard drive may be used for persistent storage 18. Other examples include optical and magnetic disks, thumb drives, and smart cards that are inserted into a drive for transfer onto another computer readable storage medium that is also part of persistent storage 18.

Network adaptor 28, in these examples, provides for communications with other data processing systems or devices. In these examples, network adaptor 28 includes one or more network interface cards. Network adaptor 28 may provide communications through the use of either or both physical and wireless communications links. Program instructions and data used to practice embodiments of the present invention may be downloaded to persistent storage 18 through network adaptor 28.

I/O interface(s) 26 allows for input and output of data with other devices that may be connected to each computer system. For example, I/O interface 26 may provide a connection to external devices 30 such as a keyboard, keypad, a touch screen, and/or some other suitable input device. External devices 30 can also include portable computer readable storage media such as, for example, thumb drives, portable optical or magnetic disks, and memory cards. Software and data used to practice embodiments of the present invention can be stored on such portable computer readable storage media and can be loaded onto persistent storage 18 via I/O interface(s) 26. I/O interface(s) 26 also connect to display 32.

Display 32 provides a mechanism to display data to a user and may be, for example, a computer monitor or virtual graphical user interface.

The components described herein are identified based upon the application for which they are implemented in a specific embodiment of the invention. However, it should be appreciated that any particular component nomenclature herein is used merely for convenience, and thus the invention should not be limited to use solely in any specific application identified and/or implied by such nomenclature.

The present invention may be a system, a method and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems) and computer program products according to embodiments of the invention. It is understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality and operation of possible implementations of systems, methods, and computer program products according to various embodiments of the present invention. In this regard, each block in the flowchart or block diagrams may represent a module, segment or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

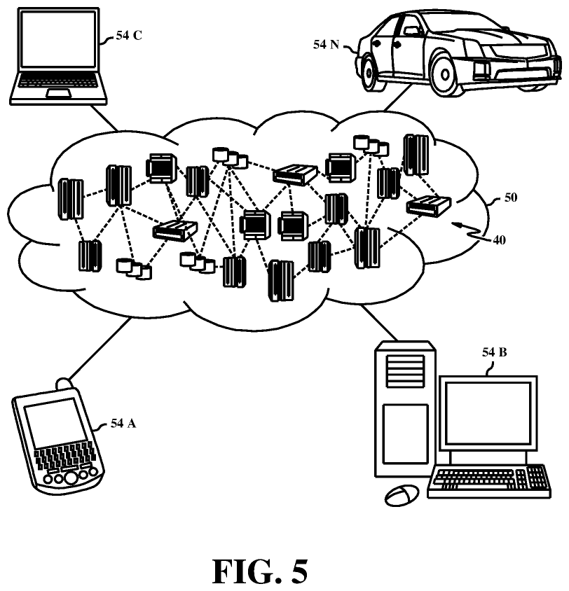

FIG. 5 is a block diagram depicting a cloud computing environment 50 in accordance with at least one embodiment of the present invention. Cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 10 and cloud computing environment 50 can communicate with any type of computerized device over any type of network and/or network addressable connection (e.g., using a web browser).

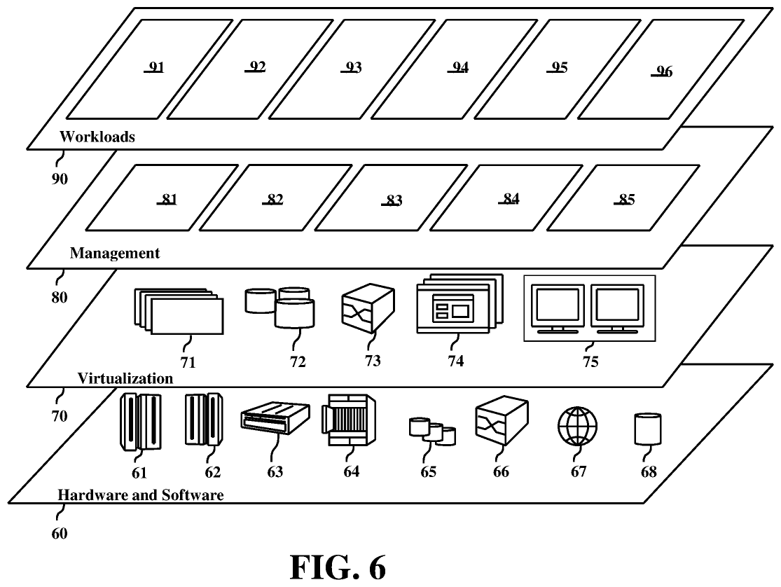

FIG. 6 is a block diagram depicting a set of functional abstraction model layers provided by cloud computing environment 50 depicted in FIG. 5 in accordance with at least one embodiment of the present invention. It should be understood in advance that the components, layers, and functions shown in FIG. 6 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and column concept prediction 96.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method for predicting a column concept, the method comprising:
building, by a processor, one or more column concept indexes based, at least in part, on a plurality of reference data sources;
identifying, by the processor, one or more concept candidates for each entity in a column based, at least in part, on the column concept indexes;
calculating, by the processor, a probability score for each of the one or more identified concept candidates based on the column concept indexes; and
predicting, by the processor, a concept for the column from the one or more identified concept candidates based, at least in part, on the calculated probability score for each of the concept candidates.

2. The computer-implemented method of claim 1, wherein identifying one or more concept candidates for each entity in a column comprises:
comparing, by the processor, categorical entities to one or more concept indexes of categorical entities.

3. The computer-implemented method of claim 2, wherein identifying one or more concept candidates for each entity in a column comprises:
comparing, by the processor, categorical entities to the one or more concept indexes of numerical entities.

4. The computer implemented method of claim 1, wherein building one or more column concept indexes comprises:
compiling, by the processor, an inverted entity concept count index for each of the plurality of reference data sources.

5. The computer-implemented method of claim 1, wherein building one or more column concept indexes comprises:
compiling, by the processor, a numerical interval tree for each of the plurality of reference data sources.

6. The computer-implemented method of claim 1, wherein calculating a probability score for each of the one or more identified concept candidates comprises:
smoothing, by the processor, the one or more identified concept candidates for each entity in a column.

7. The computer implemented method of claim 1, wherein calculating a probability score for each of the one or more identified concept candidates comprises:
validating, by the processor, concept co-occurrence of identified concept candidates for the one or more identified concept candidates.

8. A computer system for predicting a column concept, the system comprising:
a memory; and
a processor in communication with the memory, the processor being configured to perform operations comprising:
build one or more column concept indexes based, at least in part, on a plurality of reference data sources;
identify one or more concept candidates for each entity in a column based, at least in part, on the column concept indexes;
calculate a probability score for each of the one or more identified concept candidates based on the column concept indexes; and
predict a concept for the column from the one or more identified concept candidates based, at least in part, on the calculated probability score for each of the concept candidates.

9. The computer system of claim 8, wherein identifying one or more concept candidates for each entity in a column comprises operations to:
compare categorical entities to one or more concept indexes of categorical entities.

10. The computer system of claim 9, wherein identifying one or more concept candidates for each entity in a column comprises operations to:
compare categorical entities to the one or more concept indexes of numerical entities.

11. The computer system claim 8, wherein building one or more column concept indexes comprises operations to:
compile an inverted entity concept count index for each of the plurality of reference data sources.

12. The computer system of claim 8, wherein building one or more column concept indexes comprises operations to:
compile a numerical interval tree for each of the plurality of reference data sources.

13. The computer system of claim 8, wherein calculating a probability score for each of the one or more identified concept candidates comprises operations to:
smoothing the one or more identified concept candidates for each entity in a column.

14. The computer system of claim 8, wherein calculating a probability score for each of the one or more identified concept candidates comprises operations to:
validate concept co-occurrence of identified concept candidates for the one or more identified concept candidates.

15. A computer program product for predicting a column concept, the computer program product comprising one or more computer readable storage devices and program instructions sorted on the one or more computer readable storage device, the program instructions executable by a processor to cause the processors to perform a function, the function comprising:
build one or more column concept indexes based, at least in part, on a plurality of reference data sources;
identify one or more concept candidates for each entity in a column based, at least in part, on the column concept indexes;
calculate a probability score for each of the one or more identified concept candidates based on the column concept indexes; and
predict a concept for the column from the one or more identified concept candidates based, at least in part, on the calculated probability score for each of the concept candidates.

16. The computer program product of claim 15, wherein identifying one or more concept candidates for each entity in a column further comprises program instructions to:
compare categorical entities to one or more concept indexes of categorical entities.

17. The computer program product of claim 16, wherein identifying one or more concept candidates for each entity in a column further comprises program instructions to:
compare categorical entities to the one or more concept indexes of numerical entities.

18. The computer program product of claim 15, wherein building one or more column concept indexes comprises program instructions to:
compile an inverted entity concept count index for each of the plurality of reference data sources.

19. The computer program product of claim 15, wherein building one or more column concept indexes comprises program instructions to:
compile a numerical interval tree for each of the plurality of reference data sources.

20. The computer program product of claim 15, wherein calculating a probability score for each of the one or more identified concept candidates comprises program instructions to:
validate concept co-occurrence of identified concept candidates for the one or more identified concept candidates.
